(19) United States
(12) Patent Application Publication
(10) Pub. No.: US 2022/0202234 A1
(43) Pub. Date: Jun. 30, 2022

(54) CAVITY HAVING A NON-STICK AND/OR NON-WETTING COATING, COOKING APPLIANCE COMPRISING SUCH A CAVITY AND METHOD FOR MANUFACTURING A CAVITY

(71) Applicant: ELECTROLUX APPLIANCES AKTIEBOLAG, Stockholm (SE)

(72) Inventors: Jing LIU, Hangzhou (CN); Filippo TISSELLI, Forli (IT); Marco BOCKLER, Rothenburg ob der Tauber (DE); Klaus WALZLEIN, Rothenburg ob der Tauber (DE); Aynur GEREDE, Hanau (DE); Paolo CESCOT, Porcia (IT); Andrea BRATTI, Porcia (IT); Georg PAULI, Rothenburg ob der Tauber (DE); Christoph LUCKHARDT, Rothenburg ob der Tauber (DE); Tobias SCHUTZ, Rothenburg ob der Tauber (DE)

(21) Appl. No.: 17/601,546

(22) PCT Filed: Apr. 7, 2020
(86) PCT No.: PCT/CN2020/083446

§ 371 Date: Oct. 5, 2021

(30) Foreign Application Priority Data
Apr. 9, 2019 (EP) 19168020.6
Nov. 15, 2019 (EP) 19209417.5

(51) Int. Cl. A47J 36/02; F24C 15/00; B05D 3/14; C09D 5/08; C09D 183/04

(52) U.S. Cl. CPC A47J 36/025; F24C 15/005; B05D 3/148; B05D 2350/63; C09D 183/04; B05D 2202/10; B05D 2202/25; C09D 5/08

(57) ABSTRACT

A cavity (4) for a cooking appliance (2), in particular an oven cavity (4) for a domestic oven, comprising at least one cavity wall (8a, 8b, 8c, 8d) defining a cooking chamber (6) for cooking foodstuff and having an inner surface (10) facing towards the cooking chamber (6), a central opening for placing foodstuff into the cooking chamber (6), wherein the inner surface (10) is at least partially provided with a non-stick and/or non-wetting coating (16) comprising at least a first layer (18), wherein the first layer (18) is obtained by a sol-gel process from a first composition comprising a silica sol and a silane and/or wherein the cavity (4) further comprises a heat reflection shield system (26) having at least one heat reflection shield (28) to reduce the heat radiation produced by heating elements (30) being arranged within the cavity (4) against the non-stick and/or non-wetting coating (16). A cooking appliance (2), in particular a domestic oven comprising such a cavity (4) and a method for manufacturing such a cavity (4).

This application claims priority benefit to European patent application No. 19 168 020.6, filed on Apr. 9, 2019, and European patent application No. 19 209 417.5, filed on Nov. 15, 2019, the disclosures of which are hereby incorporated by reference herein in their entirety.

### TECHNICAL FIELD

The present invention relates to a cavity having a non-stick and/or non-wetting coating. In particular, the present invention relates to a cavity of a cooking appliance. Further, the present invention relates to a cooking appliance having such a cavity. Moreover, the present invention relates to a method for manufacturing a cavity, in particular a cavity of a cooking appliance, wherein the non-stick and/or non-wetting coating is applied to at least one cavity wall of the cavity.

### BACKGROUND

One problem for the customer is the cleaning of an oven after usage, especially after food items, such as cheese, sauces, oils, fat or the like, are burned onto the surface of the cavity. Therefore, there are different approaches on the market to make cleaning easier. On the one hand, so-called self-cleaning appliances with pyrolysis functionality or appliances with catalytic enamel are known already. On the other hand, there are appliances with special enamel that is more easy to clean and less sensitive to impacts and scratches, e.g. granite enamel. Furthermore, appliances with plasma treatment or steam-cleaning program to improve the cleaning procedure and the cleaning result are already on the market.

Said actual systems have different disadvantages. Appliances with pyrolysis functionality require additional components for the pyrolysis system, what leads to higher costs. Furthermore, high temperatures are needed for the cleaning process, what costs energy. Appliances with catalytic enamel require high burning temperatures of over 800° C. during its manufacturing process. Further, the catalytic enamel has a brittle surface what may be problematic during assembly. Furthermore, over time the pores of the enamel get blocked and the cleaning effect worsens.

### SUMMARY

It is an object of the present invention to provide a cavity, a cooking appliance comprising such a cavity and a method for manufacturing such a cavity, having improved properties, in particular with regard to cleaning behaviour, temperature resistance and/or surface hardness.

These and other problems are solved by the subject matter of the attached independent claims.

The first object of the present invention is achieved by a cavity according to claim 1. A cavity, in particular a cavity for a cooking appliance, in particular an oven cavity, is provided, wherein said cavity comprises at least one cavity wall defining a cooking chamber for cooking foodstuff and having an inner surface facing towards the cooking chamber. The cavity further comprises a central opening for placing foodstuff into the cooking chamber. The inner surface is at least partially provided with a ceramic non-stick and/or non-wetting coating. According to the invention, the coating comprises at least a first layer, wherein the first layer is obtained by a sol-gel process from a first composition comprising a silica sol and a silane. Alternatively or additionally, according to the invention, the cavity further comprises a heat reflection shield system having at least one heat reflection shield to reduce the heat radiation produced by heating elements being arranged within the cavity against the non-stick and/or non-wetting coating.

In other words: The first layer, hereinafter also referred to as base layer, is composed of a matrix comprising the condensation reaction product of a silica sol and a silane. Obtained by a sol-gel process from a first composition has therefore to be understood in such a way, that the first layer is obtained by means of hydrolysis and (poly-)condensation of an aqueous mixture comprising at least a silica sol and a silane. Thus, the starting materials of the first composition, namely at least silica sol, silane and water if needed, are mixed together and stirred. The mixture obtained thereof is then applied to the inner surface of the cavity wall and dried to obtain the first layer. Such a coating having one layer is known for example from EP 2 177 580 B1.

The expression “non-stick” indicates a surface that resists adherence of food items, such as cheese, sauces, oils, fat or the like, what permits easy cleaning of the cavity. The expression “non-wetting” terms a surface that repels liquids, e.g. water. The property is evidenced by a large contact angle between a drop of water and the surface on which the drop rests, wherein a contact angle of at least 95 degree is desirable.

According to the present invention, however, the “inner surface” of a cavity wall is the surface directed to the heated or heatable cooking chamber defined by said cavity walls. Accordingly, an “outer surface” of a cavity wall is the surface facing away from said cooking chamber.

The cavity comprises cavity walls, which form a cooking chamber between them, into which foodstuff may be placed to be cooked or baked. For this purpose, the cooking chamber is defined by the cavity walls, usually comprising a left and a right side wall, a bottom wall and an upper wall, a rear wall and a front wall, whereby one of the cavity walls, usually the front wall comprises a central opening for placing the foodstuff into the cooking chamber. The central opening may be closed or opened, respectively, by a door. The person skilled in the art also knows other configurations of such cavity.

The cavity may comprise further components that are provided to be attached to the cavity walls, for example backing trays or grids. Even these further components may have a comparable structure to the cavity walls, thus at least one surface of such accessory components may be coated with a ceramic non-stick and/or non-wetting coating comprising at least a first layer, wherein the first layer is obtained by a sol-gel process from a first composition comprising a silica sol and silane.

The components of the cavity, thus the cavity walls and/or further accessory components, may be integrally formed or may comprise several parts that are provided to be joined together to form a shaped structure, such as the heatable oven cavity, its frontframe or any component thereof.

The idea of the present invention is to provide a cavity with an easy to clean effect whereby the contact angle of the surface shows more than 95 degrees. Applying a non-stick and non-wetting coating by a sol-gel process has the advantage that a burning process at high temperatures for applying a non-stick coating on the cavity walls is not required what saves energy. Besides a good cleaning behaviour, said coating shows good abrasion-resistant and a great surface hardness what leads to an increased lifetime.

Heating elements, e.g. tube heating elements or grill elements, can heat up the cavity inner surface up to 500° C. For the use of a non-stick and non-wetting coating, in particular a coating obtained by a sol-gel process being described herein, that is easy to clean, the maximum temperature needs to be below about 300 to 350° C. Therefore, it is also an idea of the invention to provide a heat reflection shield system in order to shield the heating elements against the critical areas of the cavity walls in order to reduce the heat radiation. This allows the use of known heating elements that are already used when cavity surfaces are coated with enamel that is temperature resistant up to 500° C. This has the advantage that an easy clean coated oven can be created without the need to change the whole oven concept or without the need to apply a completely new heating system.

The cavity walls can be made of different materials, the material being suitable for intended use, such as stainless steel or another material that is non-corrosive itself, for example aluminium or an aluminium alloy. The disadvantage of such cavity walls is, however, that they are expensive. Therefore, in particular, the at least one cavity wall is made of corrosive steel, particularly low-carbon steel is a preferred material for the cavity wall, and is provided with an anticorrosive or preparation layer, in particular an enamel layer and/or an aluminium layer and/or a layer comprising aluminium, and the first layer is applied to said anticorrosive or preparation layer. In the case that the cavity wall is manufactured from stainless steel or another non-corrosive material, such an anticorrosive or preparation layer may, but not necessarily has to be applied for corrosion protection, but is useful for preparing the surface, thus providing a good wettability and clean surface to obtain good adhesion performances on the full surface and no detachment of the non-stick and/or non-wetting coating.

In other words: A cavity, more specific in particular the cavity walls made of stainless steel or corrosive steel comprises or comprise an anticorrosive or preparation layer, hereinafter also referred to as corrosion protection layer or preparation layer, on its inner surface, and the non-stick and/or non-wetting coating is applied to an inner surface of said corrosion protection layer or preparation layer. This is due to the reason, that the non-stick and/or non-wetting coating itself does not protect the base material or substrate, thus the cavity walls, from corrosion. Therefore, an additional corrosion protection layer is advantageous if the cavity walls are made of any corrosive material so that the non-stick and/or non-wetting coating can also be used with base material or substrate that is corrosive itself. A preparation layer is useful for all base materials in order to prepare the cavity walls for subsequent coating in order to get a wettable and clean surface.

Said enamel layer might be a so-called pyro or vitreous enamel that essentially consists of melted and fused glass powder. For applying said enamel layer to the cavity walls, high burning temperatures from about 820 to 840° C. are needed.

Another kind of enamel layer might be made of an enamel having a low softening point between 450° C. and 560° C., respectively a low glass transition temperature, a so-called “low-temperature enamel”. The softening point is defined as a temperature, respectively a temperature range, at which the material, e.g. the enamel turns from its hard and relatively brittle state into a molten or rubber-like state when temperature is increased. Therefore, said low-temperature enamel can be applied to the surface of the cavity walls at lower burning temperatures. Said enamel is for example an aluminium enamel that comprises aluminium oxide.

Compositions of such conventional enamels are known for example from WO 02/02471 A1 or GB 718,132. WO 02/02471 A1 discloses an enamel composition for use in forming an enamel cover coat comprising a glass component comprising at least a first glass frit, comprising by weight from about 30% to about 45% P₂O₅, from about 20% to about 40% Al₂O₃ from about 15% to about 35% Li₂O and Na₂O and K₂O, up to about 15% B₂O₃, up to about 15% MgO and CaO and SrO and BaO and ZnO, up to about 10% TiO₂ and ZrO₂, and up to about 10% SiO₂. The glass component may also comprise a blend of at least a first glass frit and a second glass frit. GB 718,132 discloses alkali metal aluminium phosphate vitreous enamel fits.

Another kind of enamel layer might be made of a catalytic enamel, for example known from EP 0 565 941 A1, disclosing a catalytically active coating composition comprising an enamel frit, inert substances and an oxidation catalyst, or from GB 1 418 842 disclosing a catalytically active enamel layer for a cooking appliance.

Furthermore, so-called ground coat compositions comprising generally a glassy component and an additive component might be used for forming an enamel layer that provides the effect of a rough and binding surface. Such ground coats are for example described in U.S. Pat. No. 8,778,455 B2 and comprise a combination of one or more alkali oxides, one or more alkaline earth oxides and one or more various transition metal oxides as glassy component, and additive such as fluorine.

An example for corrosive steel that is commonly used is so-called low carbon steel, typically containing a small percentage of carbon, approximately about 0.05 to 0.30% carbon.

In a preferred embodiment, the ceramic non-stick and/or non-wetting coating comprises at least a second layer being applied to an inner surface of the first layer, wherein the second layer is obtained by a sol-gel process from a second composition comprising a silica sol, a silane and a siloxane, in particular a polydimethylsiloxane. Such a coating having at least a second layer is also known from EP 2 177 580 B1.

In other words: The second layer, hereinafter also referred to as top layer, is composed of a matrix comprising the condensation reaction product of a silica sol, a silane and a siloxane. Obtained by a sol-gel process from a second composition has therefore to be understood in such a way, that the second layer is obtained by means of hydrolysis and (poly-)condensation of an aqueous mixture comprising at least a silica sol, a silane and a siloxane. Thus, the starting materials of the second composition, namely at least silica sol, silane, siloxane and water if needed, are mixed together and stirred. The mixture obtained thereof is then applied to the inner surface of the first layer and dried to obtain the second layer.

Preferably, the silica sol is present in an amount of 15 to 70 wt %, in particular in an amount of 30 to 70 wt % and/or the silane is present in an amount of 2 to 70 wt %, in particular in an amount of 10 to 40 wt %, both in the first and the second composition or first and second layer.

In particular the silane in the first and the second composition or first and second layer is an organoalkoxysilane, in particular a methyltrimethyoxysilane and/or a fluoralkoxysilane.

The first and/or the second composition or the first and/or second layer may comprise a catalyst, in particular an acidic catalyst, more preferably an organic compound containing one or more carboxyl groups and/or a mineral acid, e.g. hydrochloric acid, sulfuric acid or nitric acid. Different monocarboxylic or dicarboxylic acids like formic acid, acetic acid or oxalic acid may be mentioned here as an example for suitable catalysts.

It has been shown, that it is advantageous, if the catalyst is present in an amount of 0.1 to 2 wt %, both in the first and the second composition or first and second layer. The catalyst generally acts as a catalyst in the hydrolysis and condensation reaction and prevents too slow crosslinking.

In another preferred embodiment, the first and/or the second composition or the first and/or second layer comprise or comprises a solvent, in particular an organic solvent. Examples for organic solvents are alcoholic solvents, for example methanol, ethanol or propanol.

In particular, the solvent is present in an amount of 10 to 60 wt %, in particular in an amount of 10 to 40 wt %.

Like the second composition or second layer, the first composition or first layer may also comprise a siloxane in a preferred embodiment. Said siloxane is in particular a polydimethylsiloxane.

An advantageous amount of siloxane in the first composition or first layer as well as in the second composition or second layer is between 0.1 to 2 wt %.

In a preferred embodiment, the first composition or first layer and/or the second composition or second layer comprise or comprises pigments and/or dyes and/or filling materials and/or further additives. In particular, temperature resistant anorganic pigments are favourable.

In addition, water is added to the first composition and/or the second composition, if needed.

In a preferred embodiment, an inner surface of at least one cavity wall and/or the anticorrosive layer has a surface roughness between Ra 0.01 μm to 10.00 μm, more preferably between Ra 0.10 μm to 5.00 μm, still more preferably between Ra 0.20 μm to 5.00 μm, still more preferably between Ra 0.50 μm to 5.00 μm, still more preferably between Ra 2.00 μm to 5.00 μm, still more preferably between Ra 2.50 μm to 5.00 μm.

An advantageous surface structure may reduce the risk of peel off of the non-stick and/or non-wetting coating and at the same time allow to reduce the amount of coating and thus decrease costs. The present inventors have surprisingly found that a roughness within the above limits improves the adhesion of subsequent layers, in particular of the anticorrosive layer to the cavity wall, or of the first or any subsequent layers of the non-stick and/or non-wetting coating to the cavity wall or the anticorrosive or preparation layer.

A surface having such a good roughness can be obtained in particular by applying an anticorrosive or preparation layer of known catalytic enamels as mentioned before. Even mechanical treatment or chemical treatment or in particular laser treatment of the surface can be carried out to achieve required roughness.

A lower surface roughness—within the limits above mentioned—may be advantageous as the amount of non-stick and/or non-wetting coating can be reduced.

Preferably, a surface roughness is less than Ra 10.00 μm, preferably less than Ra 7.50 μm, more preferably less then Ra 5.00 μm.

A higher surface roughness—within the limits mentioned above—may be advantageous as this would improve adhesive capacity for the non-stick and/or non-wetting coating.

Preferably, a surface roughness is more than Ra 0.01 μm, preferably more than Ra 0.10 μm, more preferably more than Ra 0.20 μm, still more preferably more than Ra 0.50 μm, still more preferably more than Ra 1.00 μm, still more preferably more than Ra 2.00 μm.

The person skilled in the art knows various standard methods to determine the surface roughness value Ra. Particularly the surface roughness may be preferably determined in accordance with BS EN ISO 4287:2000 British standard, identical with the ISO 4287:1997 standard.

Also preferred is that the anticorrosive or preparation layer, in particular the enamel layer, has a thickness smaller than 100 μm, more preferably smaller than 80 μm, still more preferably smaller than 50 μm, still more preferably smaller than 30 μm. In particular in the case of a cavity wall made of stainless steel, it is not needed that said thin enamel layer forms a continuous layer as just a non-continuous layer already gives a favorable rough surface.

Typical enamel thickness is normally larger than 100 μm. Inventors have surprisingly found, that the enamel compositions mentioned above allow forming of thinner layers. Even it is not needed, that the metal surface is covered completely by a continuous layer to improve wetting and adhesion properties of the surface of the cavity walls. An enamel that is too thin to form a continuous layer already gives a favorable rough surface.

In a preferred embodiment, the cavity comprises a heat reflection shield system, in particular at least one heat reflection shield and said heat reflection shield system, in particular said at least one heat reflection shield has a first part for protecting a cavity top wall and at least a second part for protecting a cavity side wall from heat radiation produced by heating elements being arranged within the cavity, wherein the first and the second part have in particular different dimensions. One part is protecting the cavity top wall and the other one is protecting the cavity side wall. An asymmetric geometry and shape results specifically in a protection that works downwards the cavity side wall.

The heat reflection shield system and, respectively, the heat reflection shield can be attached to an outside rod of the heating element or alternatively to all rods of the heating element. Another possibility is to attach a heat reflection shield as a whole plate on top of the heating element. A heat reflection shield may also extend between two or more heating elements to isolate them from each other.

In another preferred embodiment, an inner surface of the heat reflection shield system, in particular the at least one heat reflection shield is shiny with a low emissivity, in particular with an emissivity between 0.1 and 0.6. This has the advantage that the radiation is reflected back into the cavity.

Also preferred is that the heat reflection shield system, in particular the at least one heat reflection shield is made of a material being temperature-resistant and/or light and/or insulating so that it shows low self-radiation behaviour. Steel, aluminum alloy, stainless steel or other metallic materials will work as simple solutions also.

It is further advantageous if the heat reflection shield system, in particular the at least one heat reflection shield comprises two or more layers of different materials. Such a “sandwich solution” combines two or more layers, wherein an inner layer is the stiff carrying geometry, an outer layer is made of a light isolating material with low radiation.

The heat reflection shield system can be pressed out of one piece of metal or be but together out of straight profiles. The heat reflection shield can be fixed to the heating element or at the inner surface of the cavity.

The second object of the present invention is achieved by a cooking appliance according to claim 15.

Such a cooking appliance comprises a heatable cavity, heating elements for heating said cavity, and a door for closing the cavity, in particular for closing a central opening of the cavity, wherein the heatable cavity is a cavity according to the present invention.

For example, a cooking appliance and/or the cavity according to the present invention is a cooking and/or baking device for cooking and/or baking of foodstuff. Such cooking appliance, preferably a cooking and/or baking device, may particularly be a cooking appliance selected from the group comprising an oven, baking oven, microwave, steam-oven, and steam-cooker.

The third object of the present invention is achieved by a method for manufacturing a cavity according to claim 16.

Such a method for manufacturing a cavity, in particular an oven cavity of a cooking appliance, having a non-stick and/or non-wetting coating on an inner surface of at least one cavity wall of a cavity comprises at least the following steps:

Firstly, an anticorrosive or preparation layer, in particular an enamel layer and/or an aluminium layer and/or a layer comprising aluminium is applied to the inner surface of the at least one cavity wall.

The person skilled in the art will acknowledge that such cavity wall can be manufactured of different material, the material being suitable for the intended use. However, the person skilled in the art will also acknowledge that particularly low carbon steel is a preferred material for the cavity wall. If low carbon steel is used as a cavity material, it is preferred to apply such anticorrosive layer, particularly an enamel layer. Alternatively, the cavity can also be manufactured from stainless steel. In such case, the step of applying an anticorrosive layer may be optional. This means that in case the cavity is manufactured from stainless steel, an anticorrosive layer may, but not necessarily has to be applied, but applying a preparation layer is advantageous also in this case in order to provide good wettability of the surface and a clean surface.

In case of an enamel layer, high burning temperatures of above 800° C. are required for burning said layer to the cavity wall. For example, the cavity walls are coated with such an anticorrosive layer by spray-painting.

Before applying the anticorrosive or preparation layer to the cavity wall, the latter can be prepared, e.g. by cleaning and/or drying the inner surface of the cavity wall and/or activating the inner surface, preferably by roughening the surface for example by mechanical treatment or chemical treatment of the inner surface of the cavity wall, in order to achieve better adhesion of the anticorrosive layer. According to a preferred embodiment, the inner surface of the cavity wall is roughened by laser-treatment.

Secondly, the first layer of the non-stick and/or non-wetting coating is applied to a surface of the anticorrosive or preparation layer.

Even here, the surface of the anticorrosive or preparation layer can be prepared, e.g. cleaning and/or drying the inner surface of the anticorrosive layer, before applying the first layer of the non-stick and/or non-wetting coating to the anticorrosive layer. Additionally or alternatively, the surface of the anticorrosive or preparation layer can be prepared by roughening the surface for example by mechanical treatment or chemical treatment of the anticorrosive layer, if present. Also preferred is even here, that the surface of the anticorrosive layer is roughened by laser-treatment.

The first layer of the non-stick and/or non-wetting coating alternatively can also be applied to a stainless steel cavity. In such case, the surface of the stainless steel cavity can be prepared, e.g. cleaning and/or drying, before applying the first layer of the non-stick and/or non-wetting coating to the cavity wall. Additionally or alternatively, the surface of the cavity wall can be prepared by roughening the surface for example by mechanical treatment, laser treatment or chemical treatment of the stainless steel cavity wall. The present inventors have surprisingly found that such pre-treatment before applying the first layer of the non-stick and/or non-wetting coating, and particularly a roughening, more particularly by laser treatment, is advantageous as the adhesion properties of the non-stick and/or non-wetting coating. Without such pretreatment, particularly such roughening, more particularly by laser treatment, the first layer, and any subsequent layer, of the non-stick and/or non-wetting coating may peel off.

A pre-treatment of the cavity wall of stainless steel or having an anticorrosive layer with laser treatment may be advantageous.

Namely, present inventors have found that the surface roughness must be optimized for industrial application. An advantageous surface structure may reduce the risk of peel off of the non-stick and/or non-wetting coating and at the same time allow to reduce the amount of coating and thus decrease costs. The adhesion of the non-stick and/or non-wetting coating to the pretreated cavity wall of stainless steel or having an anticorrosive layer may particularly depend on the surface roughness. The surface roughness may be advantageously increased by such pre-treatment, particularly laser treatment. However, a surface roughness, which is too high, may also be disadvantageous, as the adhesion of the coating may be not optimal and/or the amount of coating needed will be higher than necessary.

Preferably, a surface roughness achieved with such laser pretreatment step is between Ra 0.01 μm to 10.00 μm, more preferably between Ra 0.10 μm to 5.00 μm, still more preferably between Ra 0.20 μm to 5.00 μm, still more preferably between Ra 0.50 μm to 5.00 μm, still more preferably between Ra 2.00 μm to 5.00 μm, still more preferably between Ra 2.50 μm to 5.00 μm.

A lower surface roughness may be advantageous as the amount of non-stick and/or non-wetting coating can be reduced.

Preferably, a surface roughness achieved with such laser pretreatment step is less than Ra 10.00 μm, preferably less than Ra 7.50 μm, more preferably less then Ra 5.00 μm.

A higher surface roughness may be advantageous as this would improve adhesive capacity for the non-stick and/or non-wetting coating.

Preferably, a surface roughness achieved with such laser pretreatment step is more than Ra 0.01 μm, preferably more than Ra 0.10 μm, more preferably more than Ra 0.20 μm, still more preferably more than Ra 0.50 μm, still more preferably more than Ra 1.00 μm, still more preferably more than Ra 2.00 μm.

The person skilled in the art knows various standard methods to determine the surface roughness value Ra. Particularly the surface roughness may be preferably determined in accordance with BS EN ISO 4287:2000 British standard, identical with the ISO 4287:1997 standard.

This pretreatment may be particularly advantages in comparison to known sandblasting methods in that integration into other production equipment is possible, for example related to existing laser welding lines in oven cavities, where sandblasting equipment may need totally new equipment and specific housings, protections, or the like. Furthermore the method according to the invention is also advantageous in having no need of process material, like corundum powder usually applied in sand-blasting according to the prior art. Furthermore, the method according to the invention is also advantageous in reducing dirt occurring during the treatment according to the present invention. Still further surface cleaning after pre-treatment steps and/or before coating is advantageously reduced compared to standard sandblasting methods. And also reproducibility of surface parameter values are advantageously increased.

The person skilled in the art will recognize that various laser methods and laser equipment may be applied to achieve the described preferably surface roughness. By way of example, in a pretreatment step according to the present invention a laser of type CL100 can be applied with a focal width of 254 mm, a wave length of 1064 nm, and an optical system STAMP10 with suction removal. Thereby, the surface treatment speed may be adjusted according to the desired results and with methods well known to the person skilled in the art. For example such surface treatment speed may be approximately 10 m²/sec or higher.

The application of non-stick and/or non-wetting coatings typically requires a preliminary preparation phase of the surface that needs to be coated, in order to get a wettable and clean surface. The preparation phase is typically split in two phases, a first one for allowing a wettable surface and a second one for cleaning the surface and removing contaminations or residuals from previous steps. In order to simplify the preparation phase, according to a preferred embodiment, the component that has to be coated, in the present case the cavity walls, is subjected to an enameling process, in order to form the anticorrosive or preparation layer. Thus the anticorrosive or preparation layer is applied to the inner surface of the at least one cavity wall by an enameling process forming the anticorrosive or preparation layer having a surface roughness within the preferred values described before and/or a layer thickness smaller than 100 μm, more preferably smaller than 80 μm, still more preferably smaller than 50 μm, still more preferably smaller than 30 μm. Said properties can be achieved by using enamel compositions described before, thus conventional enamels, catalytic enamels or so-called ground compositions. We refer explicitly to the explanations and examples described in the context of the anticorrosive and preparation layer of the cavity wall.

Alternatively or additionally, a heat reflection shield system having at least one heat reflection shield is attached to an inner surface of the cavity or to a heating element of the cooking appliance.

In a preferred embodiment, the second layer of the non-stick and/or non-wetting coating is applied to a surface of the first layer in a further step, so that a cavity comprising a coating comprising base layer and top layer is obtained.

In an embodiment, wherein the cavity comprises at least two cavity walls, the method for manufacturing a cavity can comprise an additional step, namely that the cavity is provided by joining together the at least to cavity walls, in particular by means of laser welding. Even further components of the cavity, such as its frontframe or housing parts that surround the cavity walls can be joined together to each other and/or to the cavity walls by laser welding.

Novel and inventive features of the present invention are set forth in the appended claims.

### BRIEF DESCRIPTION OF THE DRAWINGS

The present invention will be described in further detail with reference to the drawings, in which

FIG. 1 illustrates a schematic view of a cooking appliance including a cavity according to an embodiment of the present invention,

FIG. 2 illustrates a cross-sectional view of a cavity wall in detail,

FIG. 3 illustrates a schematic view of a part of a cavity of a cooking appliance comprising a heat reflection shield system according to a first embodiment of the invention,

FIG. 4 illustrates a schematic view of a part of a cavity of a cooking appliance comprising a heat reflection shield system according to a second embodiment of the invention,

FIG. 5 illustrates a schematic view of a part of a cavity of a cooking appliance comprising a heat reflection shield system according to a third embodiment of the invention,

FIG. 6 illustrates a schematic view of a part of a cavity of a cooking appliance comprising a heat reflection shield system according to a fourth embodiment of the invention,

FIG. 7 illustrates a schematic view of a part of a cavity of a cooking appliance comprising a heat reflection shield system according to a fifth embodiment of the invention.

### LIST OF REFERENCE NUMERALS

2 cooking appliance
4 cavity
6 cooking chamber
8a, b, c, d cavity wall
10 surface of the cavity wall
12 anticorrosive layer
14 surface of the anticorrosive layer
16 coating
18 first layer
20 surface of the first layer
22 second layer
24 surface of the second layer
26 heat reflection shield system
28 heat reflection shield
30 heating element
32a, 32b first, second part of the heat reflection shield
34 inner surface of the heat reflection shield system
36a, 36b layers of the heat reflection shield

### DETAILED DESCRIPTION

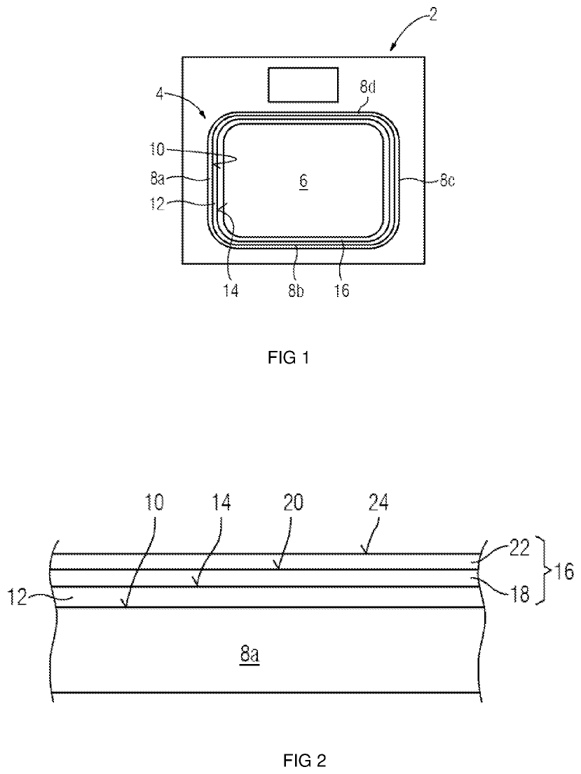

FIG. 1 illustrates a schematic view of a cooking appliance 2. Such cooking appliance 2 comprises a heatable cavity 4 according to the present invention. The cavity 4 comprises cavity walls which define a cooking chamber 6 into which foodstuff may be placed for cooking or baking. The cooking chamber 6 is defined by the cavity walls, usually comprising a left and a right side wall, 8a and 8b, respectively, a bottom wall 8c and an upper wall 8d and a rear wall and a front wall, which are not shown in FIG. 1. One of the cavity walls, usually the front wall comprises a central opening for placing the foodstuff into the cooking chamber 6. The central opening may be closed or opened by a door that may be a part of the front wall. The cooking appliance 2 usually further comprises also heating elements (not shown in FIG. 1) for heating the cooking chamber 6 and therefore heating food that has been placed therein to be cooked. Such heating elements may be disposed at one of the cavity walls.

The cavity walls 8a, 8b, 8c, 8d are exemplary made of corrosive steel, actually a low carbon steel. In order to prevent the cavity 4 from corrosion, the cavity walls 8a, 8b, 8c, 8d are provided with an anticorrosive or preparation layer 12, in the present case an enamel layer, in particular formed by a ground coat composition, that has burned to the cavity walls 8a, 8b, 8c, 8d at temperature of 820° C. The anticorrosive or preparation layer 12 has a surface roughness of 2.5 μm and a layer thickness of 20 μm.

The cavity walls 8a, 8b, 8c, 8d are further provided with a non-stick and/or non-wetting coating 16 comprising a first layer 18 as a base layer and a second layer 22 as a top layer. The first layer 18 is applied to a surface 14 of the anticorrosive or preparation layer 12. A cross-sectional view of a cavity wall 8a is exemplary shown in detail in FIG. 2.

Both, the first layer 18 and the second layer 22 are obtained by a sol-gel process. For production of the first layer 16, a colloidal silica sol, which is pure SiO₂, an organoalkoxysilane, which is an organic-inorganic hybrid material and presently methyltrimethyoxysilane, and an acid catalyst, presently acetic acid are mixed and stirred for about 2 hours at room temperature in order to effect a condensation reaction. The weight proportion of organoalkoxysilane is about 10 to 40 wt %, silica sol is present in an amount of 30 to 70 wt %. Adding acetic acid in an amount of 0.1 to 2 wt % is sufficient for accelerating the condensation reaction.

Then, a solvent, presently propanol, is added in an amount of 10 to 40 wt %. Pigments are added and further additives can be additionally added at this step.

For production of the second layer 22, colloidal silica sol, siloxane and a solvent, even here propanol, are mixed. Organoalkoxysilane and an acid catalyst, presently acetic acid are then added. Even said mixture is mixed and stirred for about 2 hours at room temperature. The weight proportion of organoalkoxysilane is about 10 to 40 wt %, silica sol is present in an amount of 30 to 70 wt %, acetic acid is present in an amount of 0.1 to 2 wt %. Siloxane, presently polydimethylsiloxane, is added in an amount of 0.1 to 2 wt %.

Then, a solvent, presently even here propanol, is added in an amount of 10 to 40 wt %. Pigments are added and further additives can be additionally added at this step.

For manufacturing a cavity 4 having a non-stick and/or non-wetting coating 16 on an inner surface 10 of the cavity walls 8a, 8b, 8c, 8d, the anticorrosive or preparation layer 12, presently an enamel layer is applied to the inner surface 10 of the cavity walls 8a, 8b, 8c, 8d in a first step. In order to improve adhesion properties of the inner surface 10 of the cavity walls 8a, 8b, 8c, 8d, the latter is roughened before applying the anticorrosive or preparation layer 12 by laser treatment.

In a second step, the first layer 18 is applied to the surface 14 of the anticorrosive or preparation layer 12. In order to improve adhesion properties of the anticorrosive or preparation layer 12, the latter is prepared by an enameling process.

In a third step, the second layer 22 is applied to the surface 20 of the first layer 18. The first layer 16 as well as the second layer 22 are sprayed on the surface 14 of the anticorrosive or preparation layer 12 or the surface 20 of the first layer 16 and dried. The first layer 16 is preferably at least still wet during the second layer 22 is applied.

The present invention, thus a cavity having a non-stick and/or non-wetting coating and a cooking appliance having such a cavity shows an improved cleaning behaviour. The cavity or the coating respectively is abrasion-resistant and shows a greater surface hardness what leads to an increased lifetime. Furthermore the coating has shown a good adhesion on the cavity wall, in particular on the surface of the anticorrosive layer. As the coating is produced by a sol-gel process, a (second) burning step at high temperatures is not necessary.

The cavity 4 further comprises a heat reflection shield system 26 having at least one heat reflection shield 28 to reduce the heat radiation produced by heating elements 30 being arranged within the cavity 4 against the non-stick and/or non-wetting coating 16. Each of the FIGS. 3 to 7 shows a part of the cavity 4 with different embodiments of such a heat reflection shield system 26.

According to FIG. 3, the cavity 4 comprises a heat reflection shield system 26 with one heat reflection shield 28 that is applied to an outside rod of the heating element 30. The heat reflection shield 28 has a first part 32a for protecting a cavity top wall 8d and a second part 32b for protecting a cavity side wall 8a. The first and the second part 32a, 32b have different dimensions, the second part 32b that extends downwards the cavity side wall has larger extension than the first part 32a. The heat reflection shield 28 is made of a material being temperature-resistant, light and insulating.

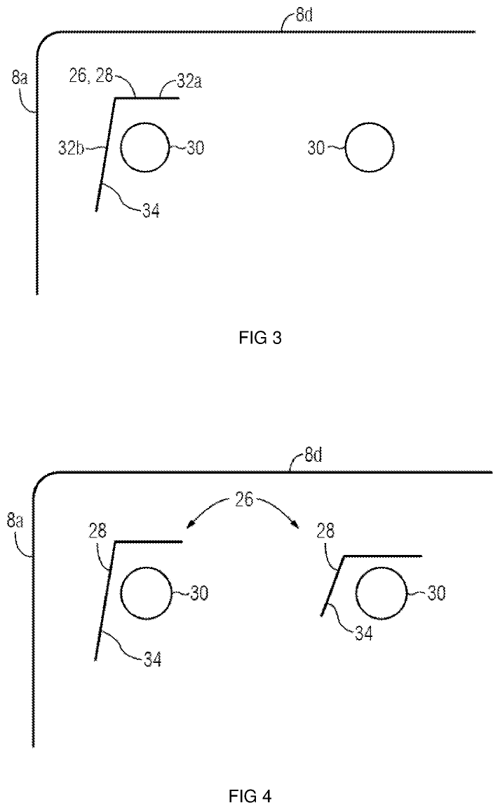

FIG. 4 shows a cavity 4 having a heat reflection shield system 26 with exemplary two heat reflection shields 28 each being applied to a heating rod of the heating element 30. A heat reflection shield 28 can be applied to all rods of the heating element 30. The heat reflection shield 28 is made of a material being temperature-resistant, light and insulating.

FIG. 5 shows an alternative embodiment, wherein a whole plate 28 is applied on top of the heating element 30 as a whole heat reflection shield 28. The heat reflection shield 28 according to FIG. 4 and FIG. 5 have the same functional geometry. The heat reflection shield 28 is made of a material being temperature-resistant, light and insulating.

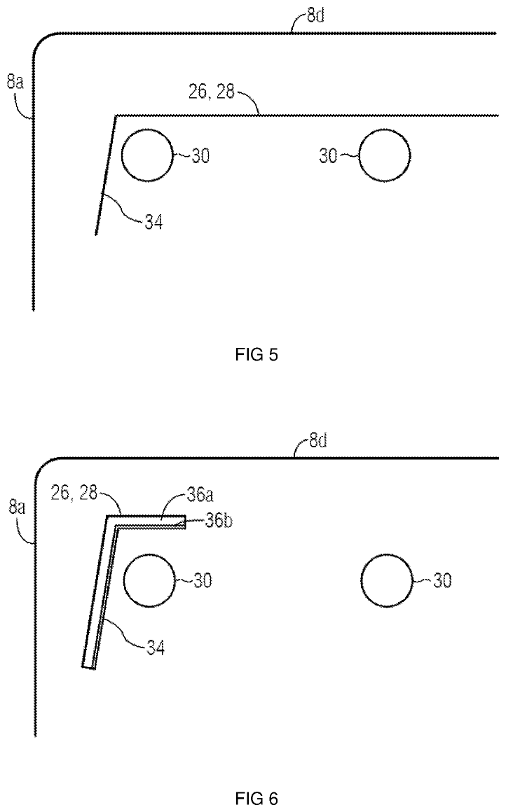

FIG. 6 shows an embodiment wherein the heat reflection shield 28 comprises two layers 36a, 36b made of different materials. The inner layer 36b is the stiff carrying geometry, the outer layer 36a is the light isolating material with low radiation.

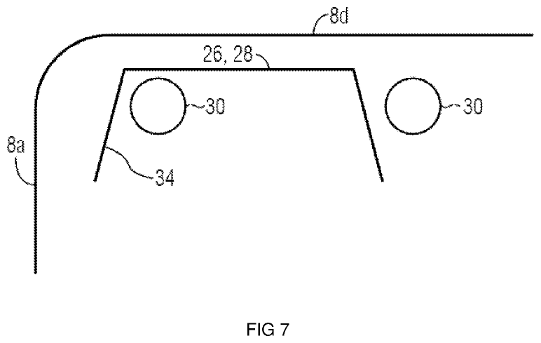

FIG. 7 shows an embodiment wherein the heat reflection shield 28 has such a shape that two rods of the heating element 30 are isolated from each other by said heat reflection shield 28.

All of the above heat reflection shields 28 have an inner surface 34 that is shiny with an emissivity between 0.1 and 0.6.

Although illustrative embodiments of the present invention have been described herein with reference to the accompanying drawings, it is to be understood that the present invention is not limited to those precise embodiments, and that various other changes and modifications may be affected therein by one skilled in the art without departing from the scope or spirit of the invention. All such changes and modifications are intended to be included within the scope of the invention as defined by the appended claims.

1. A cavity for a cooking appliance, comprising:
a cavity wall defining a cooking chamber for cooking foodstuff and having an inner surface facing towards the cooking chamber,
a central opening for placing foodstuff into the cooking chamber, and
a non-stick and/or non-wetting coating applied to the inner surface at least partially,
wherein:
the non-stick and/or non-wetting coating comprises a first layer obtained by a sol-gel process from a first composition comprising a silica sol and a silane, and/or
the cavity further comprises a heat reflection shield system having a heat reflection shield to reduce heat radiation produced by heating elements arranged within the cavity against the non-stick and/or non-wetting coating.

2. The cavity according to claim 1, wherein the cavity wall is made of stainless steel, or is made of corrosive steel provided with an anticorrosive or preparation layer comprising an enamel layer and/or an aluminium layer and/or a layer comprising aluminium, wherein the first layer is applied to said anticorrosive or preparation layer.

3. The cavity according to claim 1, wherein the non-stick and/or non-wetting coating comprises a second layer applied to the first layer, wherein the second layer is obtained by a sol-gel process from a second composition comprising a silica sol, a silane and a siloxane.

4. The cavity according to claim 1,
wherein in said first composition the silica sol is present in an amount of 15 to 70 wt % and/or the silane is present in an amount of 2 to 70 wt %.

5. The cavity according to claim 1, wherein the silane is an organoalkoxysilane and/or a fluoralkoxysilane.

6. The cavity according to claim 3, wherein the first composition and/or the second composition comprise or comprises an organic solvent.

7. The cavity according to claim 6,
wherein the solvent is present in an amount of 10 to 60 wt % in the first composition and/or the second composition, respectively.

8. The cavity according to claim 1, wherein the first composition comprises a polydimethylsiloxane.

9. The cavity according to claim 3,
wherein the siloxane is present in the second composition in an amount of 0.1 to 2 wt %.

10. The cavity according to claim 3, wherein the first composition and/or the second composition comprise or comprises pigments and/or dyes and/or filling materials and/or further additives.

11. The cavity according to claim 2, wherein the inner surface of the cavity wall and/or the anticorrosive or preparation layer has a surface roughness between Ra 0.50 μm to 5.00 μm.

12. The cavity according to claim 2, wherein the enamel layer has a thickness smaller than 50 μm, still more preferably smaller than 30 μm.

13. The cavity according to claim 1,
wherein the heat reflection shield has a first part for protecting a cavity top wall and a second part for protecting a cavity side wall, wherein the first and the second part have different dimensions.

14. The cavity according to claim 1,
wherein an inner surface of the heat reflection shield: is shiny with an emissivity between 0.1 and 0.6, and/or is made of a material that is temperature-resistant and/or insulating, and/or comprises two or more layers of different materials.

15. A cooking appliance comprising:
the cavity for a cooking appliance according to claim 1 heatable cavity,
heating elements for heating said cavity, and
a door for closing the cavity.

16. A method for manufacturing a cavity of a cooking appliance, having a non-stick and/or non-wetting coating on an inner surface of a cavity wall of the cavity, comprising:
applying an anticorrosive or a preparation layer comprising an enamel layer and/or an aluminium layer and/or a layer comprising aluminium to the inner surface of the cavity wall,
applying a first layer of the non-stick and/or non-wetting coating to a surface of the anticorrosive or preparation layer and/or attaching a heat reflection shield system having a heat reflection shield to the inner surface of the cavity or to a heating element of the cooking appliance.

17. The method for manufacturing a cavity according to claim 16, wherein a second layer of the non-stick and/or non-wetting coating is applied to a surface of the first layer.

18. The method for manufacturing a cavity according to claim 16, wherein the inner surface of the cavity wall and/or the anticorrosive or preparation layer is or are roughened before applying the non-stick and/or non-wetting coating by laser-treatment.

19. The method for manufacturing a cavity according to claim 16, wherein the anticorrosive or preparation layer is applied to the inner surface of the cavity wall by an enameling process.

20. A cooking appliance comprising: a cooking chamber defined at least in part by a cavity side wall made of low-carbon steel and a cavity top wall, a heating element within the cooking chamber and adapted to supply heat for cooking therein, an anticorrosive layer disposed on an inner surface of said cavity side wall, a non-stick and non-wetting coating having a water-contact angle of at least 95° disposed on an inner surface of said anticorrosive layer, and a heat shield within the cooking chamber; said heat shield having an emissivity between 0.1 and 0.6 and comprising a first part adapted to reduce incidence of radiation from said heating element on said top wall, and a second part adapted to reduce incidence of radiation from said heating element on said non-stick and non-wetting coating on the side wall; said anticorrosive layer being an enamel layer having a thickness smaller than 50 μm; said non-stick and non-wetting coating comprising a first layer comprising a first matrix formed as a condensation reaction product of a first mixture comprising a silica sol and a silane, and a second layer comprising a second matrix formed as a condensation reaction product of a second mixture comprising silica sol, a silane and a siloxane, wherein the first layer of said non-stick and non-wetting coating is disposed on an inner surface of said anticorrosive layer, and the second layer of said non-stick and non-wetting coating is disposed on an inner surface of said first layer; the inner surface of said anticorrosive layer having a surface roughness of Ra 0.50 μm to 5.00 μm when measured according to ISO 4287:1997; the silane in each of said first and second mixtures comprising at least one of organoalkoxysilane or fluoralkoxysilane.
